(19) United States
(12) Patent Application Publication
(10) Pub. No.: US 2019/0272453 A1
(43) Pub. Date: Sep. 5, 2019

(54) DUAL SIM CARD CONNECTOR

(71) Applicant: Apple Inc., Cupertino, CA (US)

(72) Inventors: Brian A. Argyres, Palo Alto, CA (US); Sherry Cao, Cupertino, CA (US); Sawyer I. Cohen, Menlo Park, CA (US); Ibuki Kamei, San Jose, CA (US); Kenn I. Peterson, Seattle, WA (US); Jason S. Sloey, Cedar Park, TX (US); Daniel C. Wagman, Scotts Valley, CA (US); Benjamin J. Pope, Mountain View, CA (US); Tang Y. Tan, Palo Alto, CA (US); Richard Hung Minh Dinh, Saratoga, CA (US)

(21) Appl. No.: 16/123,696

(22) Filed: Sep. 6, 2018

Related U.S. Application Data
(60) Provisional application No. 62/637,222, filed on Mar. 1, 2018.

(51) Int. Cl. G06K 13/08; G06K 7/00; H01R 27/00; H01R 13/24; H04B 1/3816; H04M 1/02

(52) U.S. Cl. CPC G06K 13/0831; G06K 7/0021; H01R 27/00; G06K 7/0039; H04M 2250/14; H01R 13/24; H04B 1/3816; H04M 1/026; G06K 7/0056

(57) ABSTRACT

A dual subscriber identity module (SIM) card connector is provided that includes a lower connector housing portion having a bottom surface and an upper connector housing portion having a top surface. The upper connector housing portion is coupled to the lower connector housing portion to define an opening for a receiving space between the upper and lower connector housing portions. The opening and receiving space are sized and shaped to slidably receive a SIM card tray. The connector includes a first plurality of electrical contacts disposed at the bottom surface of the lower connector housing portion and configured to make contact with a first SIM card disposed on a first side of the SIM card tray when the tray is received within the receiving space. The connector includes a second plurality of electrical contacts disposed at the top surface of the upper connector housing portion and configured to make contact with a second SIM card disposed on a second side of the SIM card tray opposite the first side when the tray is received within the receiving space.

### CROSS REFERENCES TO RELATED APPLICATIONS

This application claims priority to U.S. Provisional Patent Application No. 62/637,222, filed on Mar. 1, 2018, and titled “Dual Sim Card Connector,” the disclosure of which is hereby incorporated by reference in its entirety for all purposes.

### FIELD

The described embodiments relate generally to SIM card connectors that are contained within the housing of an electronic device, such as a mobile telephony device, and more particularly to dual SIM card connectors.

### BACKGROUND

Currently there are a wide variety of electronic devices that function as a mobile telephonic devices. Such electronic devices may include a subscriber identity module (SIM) card that is used to identify and authenticate subscribers on a cellular telephone system. The SIM card may be configured to be accessible by a user so the user can change cellular providers, the phone number assigned to the electronic device or perform other system configuration changes by installing a different SIM card. Further, it may be desirable for the electronic device to be able to carry more than one SIM card such that a user may more conveniently change or switch between different cellular providers, phone numbers, or other system configurations.

In some electronic devices, an option to carry more than one SIM card (e.g., two or more SIM cards) is desirable. The SIM cards may be held in a tray and may be accessible from an outside surface of the electronic device to make it available to the user. In such applications, it may be desirable to have the SIM card connector to be compact so it does not require a large penetration aperture through the exterior shell of the electronic device. In addition, it may be beneficial for the SIM card connector to be configured to impede moisture ingression into the electronic device to protect the internal components from damage.

New SIM card connectors may require new features or new methods of implementing the connectors to reduce the size of the penetration aperture through the shell of the electronic device, to improve the ability of the electronic device to impede moisture ingression, and to allow the electronic device to more conveniently carry more than one SIM card simultaneously.

### SUMMARY

Some embodiments of the present invention relate to SIM card connectors that can receive one or more SIM cards. The SIM card connector may include a lower connector housing portion having a bottom surface and an upper connector housing portion having a top surface. The upper connector housing portion is coupled to the lower connector housing portion to define an opening and a receiving space between the upper and lower connector portions. The opening and receiving space are sized and shaped to slidably receive a SIM card tray. The connector includes a first plurality of electrical contacts disposed at the bottom surface of the lower connector housing portion and configured to make contact with a first SIM card disposed on a first side of the SIM card tray when the SIM card tray is received within the receiving space. The connector includes a second plurality of electrical contacts disposed at the top surface of the upper connector housing portion and configured to make contact with a second SIM card disposed on a second side of the SIM card tray opposite the first side when the SIM card is received within the receiving space.

In some embodiments, the lower and upper connector housing portions are integrally formed. In certain embodiments, the upper connector housing portion includes a pair of opposing sidewalls and a rear wall extending between the opposing sidewalls. The opposing sidewalls and rear wall extend from the top surface and are configured to be coupled to the lower connector housing portion. The lower connector housing portion may include a pair of opposing sidewalls and a rear wall extending between the opposing sidewalls. The opposing sidewalls and rear wall extend from the bottom surface and are configured to be coupled to the upper connector housing portion. In various embodiments, the first and second plurality of electrical contacts are configured to be electrically coupled to a circuit board. In yet further embodiments, each of the SIM cards has a plurality of SIM card contacts configured to be coupled to the first or second plurality of electrical contacts when the SIM card tray is in a latched position within the receiving space.

In certain embodiments, the opening is disposed at a front face of the upper and lower connector housing portions and the front face is configured to mate to a housing of an electronic device with a gasket such that a seal is formed between the connector and the housing of the electronic device. In various embodiments, the bottom surface of the lower connector housing portion includes a first ramped surface and the top surface of the upper connector housing portion includes a second ramped surface. The first and second ramped surfaces configured to maintain a position of the SIM card tray within the receiving space when received within the receiving space.

In other embodiments, the SIM card connector includes the SIM card tray. The SIM card tray is configured to hold the first and second SIM cards in a stacked configuration such that SIM card contacts of the respective SIM cards face opposing directions. The SIM card tray can include receptacles on opposing sides to hold the first and second SIM cards, respectively. Each of the receptacles of the SIM card tray can include rear chamfered edges.

In some embodiments, an electronic device is provided that includes a housing, a connector enclosure disposed within the housing having a receiving opening that communicates with a cavity. The electronic device includes a tray configured to hold a subscriber identity module (SIM) card and be inserted within the cavity through the receiving opening and a first plurality of electrical contacts disposed on a lower surface of the connector enclosure. The electronic device further includes a second plurality of electrical contacts disposed on an upper surface of the enclosure, wherein one of the first or second plurality of electrical contacts is configured to make a plurality of electrical connections between the SIM card and a circuit board when the tray is received within the cavity. In some embodiments, the tray is configured to hold only one SIM card.

In various embodiments, the tray includes receptacles on opposing sides configured to hold first and second SIM cards in a stacked configuration such that electrical contacts of the first SIM card make contact with the first plurality of electrical contacts and electrical contacts of the second SIM card make contact with the second plurality of electrical contacts when the tray is received with the cavity. In certain embodiments, each of the receptacles includes a rear chamfered edge. In some embodiments, at least one of the receptacles includes a retention mechanism configured to secure the first or second SIM card within the receptacle.

In some embodiments, the upper and lower surfaces of the enclosure include first and second ramped surfaces, respectively. In further embodiments, the electronic device includes a cover configured to be disposed over at least a portion of the connector enclosure.

In certain embodiments, a subscriber identity module (SIM) tray assembly is provided that includes first and second opposing sides. A first receptacle on the first side is configured to hold a first SIM card therein and a second receptacle on the second side is configured to hold a second SIM card therein such that the first and second SIM cards are held in a stacked configuration. Each of the first and second receptacles includes a rear chamfered edge. In some embodiments, at least one of the receptacles includes a retention mechanism configured to secure the first or second SIM card within the receptacle.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is a front perspective view of an electronic device that incorporates a dual SIM card connector according to an embodiment of the invention;

FIGS. 2A and 2B are perspective and exploded views, respectively, of the dual SIM card connector shown in FIG. 1;

FIG. 3A is a bottom perspective view of the SIM card tray shown in FIG. 2 and FIG. 3B illustrates a first SIM card held within a first receptacle of the SIM card tray;

FIG. 3C is a top perspective view of the SIM card tray of FIG. 3A;

FIG. 3D is a top perspective view of the SIM card tray of FIG. 3A with a second SIM card positioned in a second receptacle of the SIM card tray;

FIG. 4A is a cross-sectional plan view of a portion of the electronic device illustrated in FIG. 1 in the region of the SIM card connector with portions of the SIM card connector removed and the SIM card tray illustrated in an installed position;

FIG. 4B is a cross-sectional view of portions of the electronic device and the SIM card connector illustrated in FIG. 4A; and

FIG. 4C is a detailed view of FIG. 4B.

### DETAILED DESCRIPTION

Some embodiments of the present invention relate to SIM card connectors and methods of employing such connectors in electronic devices. Some embodiments relate to dual SIM card connectors having a SIM card tray configured to hold one or more SIM cards while maintaining a relatively small penetration aperture through the housing of the electronic device which maximizes the strength of the housing. In addition, the connector may enable the SIM card connector to be formed such that it is substantially liquid-tight. The SIM card connector may be sealed with a gasket to the housing of the electronic device so the electronic device can be protected from moisture ingression through the SIM card connector. The SIM card connector may receive or carry one or more SIM cards. While the present invention can be useful for a wide variety of configurations, some embodiments of the invention are particularly useful for SIM card connectors with SIM card trays configured to hold two SIM cards in a stacked configuration, as described in more detail below.

For example, in some embodiments an injection molded plastic connector housing may have a recess sized to receive a SIM card(s) or a SIM card tray through a receiving opening at the front of the connector housing. The SIM card(s) may be oriented in a stacked or back-to-back configuration or layout. A slot may be disposed in the connector housing adjacent to the recess and a pushrod may be disposed in the slot such that it can be linearly translated. An ejector arm may be pivotably coupled to the connector base and configured to be rotated when the pushrod is linearly translated towards the back of the connector. The ejector arm may then rotate and push against the SIM card or the SIM card tray and cause it to be ejected. A cover may be disposed over the connector base, creating an electromagnetic shield or providing mechanical stability for the SIM card connector. A stacked configuration as described herein removes the need for an in-line or side-by-side SIM card connector layout. Therefore, embodiments of connectors described herein may require removal of less housing material and/or have a smaller footprint relative to current designs.

In order to better appreciate the features and aspects of SIM card connectors for electronic devices according to the present invention, further context for the invention is provided in the following section by discussing one particular implementation of a SIM card connector according to embodiments of the present invention. These embodiments are for example only and other embodiments may be employed in other SIM card connectors such as, but not limited to those used in all types of computers, watches, media players and other devices.

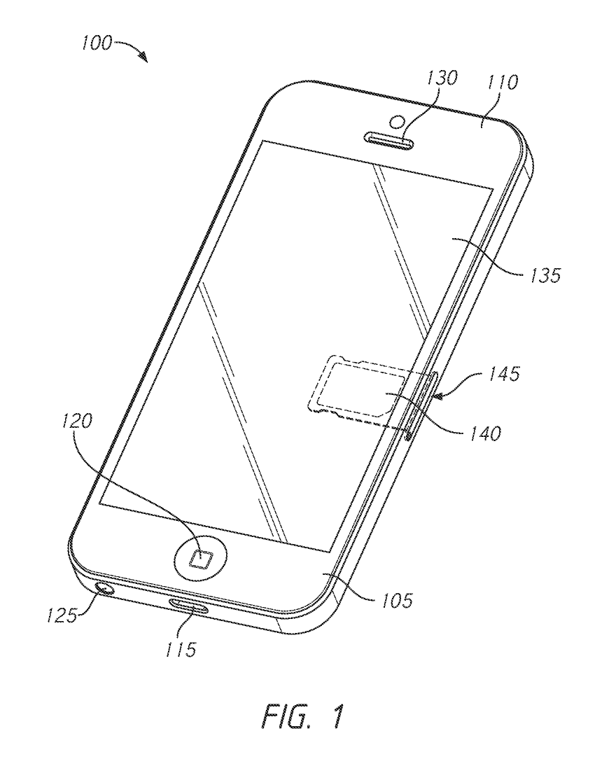

FIG. 1 depicts an illustrative rendering of an electronic device 100 that includes a housing 105 with exterior surface 110 having a receptacle connector 115. The electronic device may further include a multipurpose button 120 as an input component, one or more microphones 125, one or more speakers 130, and a touch screen display 135 as both an input and output component. Electronic device 100 also has one or more SIM cards 140 within a SIM card connector 145, as described in more detail below. In some embodiments, electronic device 100 may function as a cellular telephone and SIM cards 140 may be used to authenticate and identify electronic device 100 on a respective telephone network.

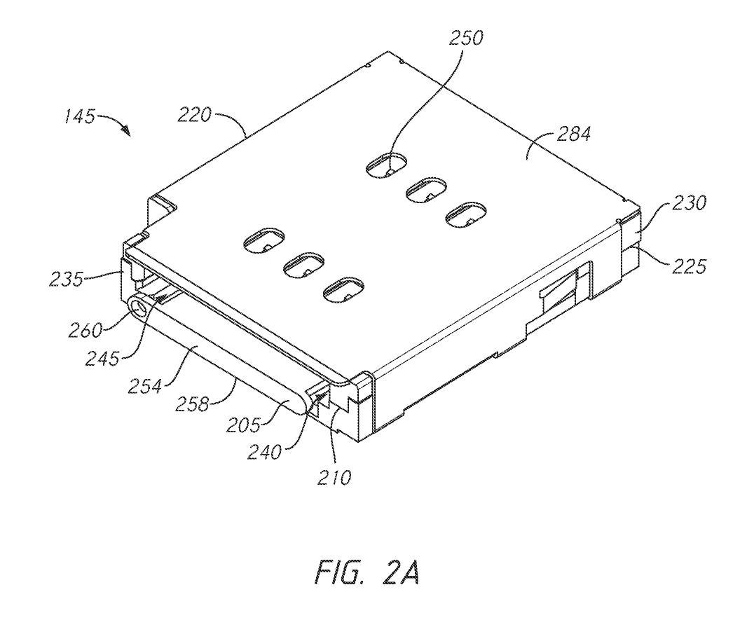

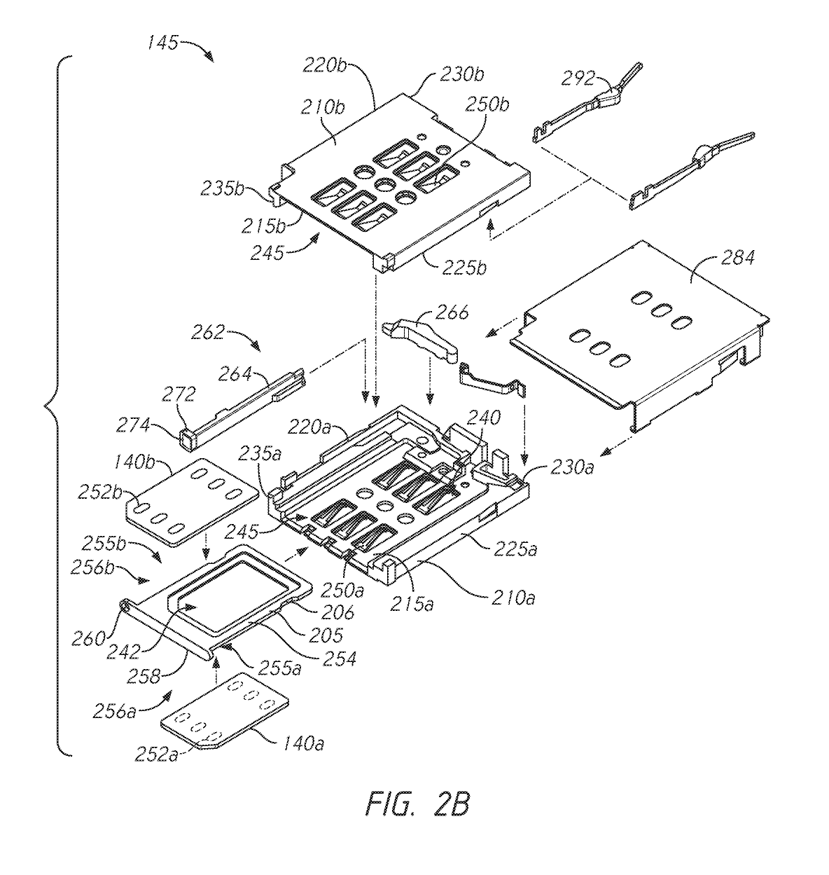

Now referring to FIGS. 2A-2B together, perspective and exploded views, respectively, of SIM card connector 145, SIM card tray 205, and SIM cards 140 (e.g., identified individually as a first SIM card 140a and a second SIM card 140b) are illustrated. In some embodiments, the first SIM card 140a may fit within a first side of SIM card tray 205. The second SIM card 140b may fit within a second side opposite the first side of SIM card tray 205 such that the SIM cards 140 are arranged in a stacked configuration when secured in the SIM card tray 205. In other embodiments, the second SIM card 140b may also fit within the first side and the first SIM card 140a may fit within the second side of SIM card tray 205. In some embodiments, the first and second SIM cards 140 are the same type of SIM cards (e.g., standard-, micro-, nano-SIM cards). In other embodiments, the first and second SIM cards 140 are different types of SIM cards. In yet further embodiments, only one of the first or second SIM cards 140a or 140b is disposed in one of the first or second sides of SIM card tray 205. The SIM card tray 205 may be received by SIM card connector 145, as discussed in more detail below.

SIM card connector 145 includes a connector housing 210 (e.g., an enclosure). The connector housing 210 may include first and second opposing sidewalls 220, 225, and a rear wall 230 extending between top and bottom surfaces and the first and second opposing sidewalls 220, 225 of the housing 210. SIM card connector 145 may further have a front face 235 opposite rear wall 230. Further, connector housing 210 defines a cavity 240 (e.g., a receiving space, recess, receptacle) having a receiving opening 245 at front face 235. In some embodiments, the receiving opening 245 is defined by the top surface, bottom surface, and opposing sidewalls of the connector housing 210. Cavity 240 may be sized and shaped to receive SIM card tray 205 through receiving opening 245. In various embodiments, one or more SIM cards 140 may be held within SIM card tray 205 and received through receiving opening 245 into cavity 240. In other embodiments, the SIM cards 140 may not have a tray and may be directly received through the receiving opening 245 into cavity 240

The connector housing 210 may include a lower connector housing portion 210a and an upper connector housing portion 210b. In some embodiments, lower connector housing portion and the upper connector housing portion are separate components configured to be coupled or mounted to each other. For example, they can be separate components that are physically or mechanically joined. In other embodiments, lower and upper connector housing portions are integrally formed or part of an integral unibody housing. In some embodiments, the lower connector housing portion 210a includes a bottom surface 215a, first and second opposing sidewalls 220a, 225a, and a rear wall 230a extending between the first and second opposing sidewalls. First and second sidewalls 220a, 225a and rear wall 230a extend from bottom surface 215a. The upper connector housing portion 210b includes a top surface 215b, first and second opposing sidewalls 220b, 225b, and a rear wall 230b extending between the first and second opposing sidewalls. First and second sidewalls 220b, 225b and rear wall 230b extend from top surface 215b. Further, the lower and connector housing portions 210a, 210b may include lower and upper front face portions 235a, 235b.

Upper connector housing portion 210b is configured to be coupled or mounted to lower connector housing portion 210a. In some embodiments, rear wall 230b and opposing sidewalls 220b, 225b of upper connector housing portion 210b at least partially overlap or extend over respective rear wall 230a and opposing sidewalls 220a, 225a of lower connector housing portion 210a when upper connector housing portion is disposed over lower connector housing portion in an assembled configuration. Further, the upper and lower connector housing portions 210 may define the cavity 240 having the receiving opening 245 at front face 235. In some embodiments, the receiving opening 245 is defined by the top surface 215b, bottom surface 215a, and opposing sidewalls (e.g., sidewalls 220a, 225a). As discussed above, the cavity 240 may be sized and shaped to receive SIM card tray 205 through receiving opening 245. In other embodiments, the SIM card(s) 140 may be directly received through the receiving opening 245 into cavity 240. In various embodiments, connector housing 210 (e.g., upper or lower connector housing portions 210a, 210b) may be made from a plastic material, such as, a liquid crystal polymer.

SIM card connector 145 may include a plurality of electrical contacts 250. In some embodiments, the plurality of electrical contacts 250 include a first plurality of electrical contacts 250 at a bottom surface of the connector housing 210 (e.g., in locations such that they are configured to make electrical contact with a plurality of SIM card contacts 252 on a first SIM card) and a second plurality of electrical contacts 250 at a top surface of the connector housing 210 (in locations such that they are configured to make electrical contact with a plurality of SIM card contacts 252 on a second SIM card). For example, the first plurality of electrical contacts 250a may be positioned at bottom surface 215a of lower connector housing portion 210a in locations such that they make electrical contact with a plurality of SIM card contacts 252 on a first SIM card (e.g., the first SIM card 140a) when the first SIM card is partially or fully inserted into cavity 240. The second plurality of electrical contacts 250b may be positioned at top surface 215b of upper connector housing portion 210b in locations such that they make electrical contact with a plurality of SIM card contacts 252 on a second SIM card (e.g., the second SIM card 140b). In various embodiments, the plurality of electrical contacts 250 may be insert molded within respective upper and lower connector housing portions 210a, 210b, while in some embodiments they may be retained by the connector housing portions with other means such as a snap fit. In some embodiments, the plurality of electrical contacts 250 may be made from a metal such as a copper alloy and may be plated with one or more metals such as nickel or gold. The plurality of electrical contacts 250 may be configured to be in electrical communication with corresponding SIM card contacts 252 of one or more SIM cards 140 and a printed circuit board (e.g., a main logic board) of electronic device 100, as discussed in more detail below.

As discussed above, one or more SIM cards 140 (e.g., one or two SIM cards) may be held within SIM card tray 205 (e.g., on opposing sides of SIM card tray 205). SIM card tray 205 may include a frame 254 with a first receptacle 256a on a first side 255a and a second receptacle 256b on a second side 255b opposite the first side 255a. The SIM card tray 205 is configured to hold a first SIM card (e.g., the first SIM card 140a) and a second SIM card (e.g., second SIM card 140b) within the first and second receptacles 256a, 256b, respectively. The SIM cards 140 are held in a “back-to-back” or “stacked” configuration (e.g., they are not positioned in a substantially same horizontal plane) such that respective SIM card contacts (e.g., 252a and 252b) face opposing directions (e.g., away from each other). The SIM card tray 205 may hold both SIM cards 140 simultaneously, or only a single SIM card (e.g., first or second SIM cards 140a, 140b within one of the first or second receptacles 256a, 256b). While first SIM card 140a is illustrated as being held in first receptacle 256a and second SIM card 140b being held in second receptacle 256b, in other embodiments, SIM cards 140 may be held in either first receptacle 256a or second receptacle 256b as desired by a user. In yet other embodiments, first and second receptacles 256 may be configured to hold different types of SIM cards as discussed above.

In the illustrated embodiment, first SIM card 140a is held or configured to be held in first receptacle 256a such that the SIM card contacts 252a may be accessible to (e.g., mate with or contact) the first plurality of electrical contacts 250a when SIM card tray 250 is partially or fully received within cavity 240 of SIM card connector 145. Likewise, when second SIM card 140b is held in second receptacle 256b, the SIM card contacts 252b may be accessible to the second plurality of electrical contacts 250b when SIM card tray 250 is partially or fully received within cavity 240 of SIM card connector 145. However, in other embodiments, when SIM card 140a is held in second receptacle 256b, the SIM card contacts 252a may be accessible to the second plurality of electrical contacts 250b. Likewise, when second SIM card 140b is held in first receptacle 256a, the SIM card contacts 252b may be accessible to the first plurality of electrical contacts 250a. Further, in various embodiments, SIM card connector may also be configured to receive SIM card trays with only a single receptacle (e.g., configured to hold only a single SIM card tray) either on a top side or a bottom side of the tray. In this manner, SIM card connector 145 may receive (e.g., provide interchangeability between) dual and/or single SIM card trays.

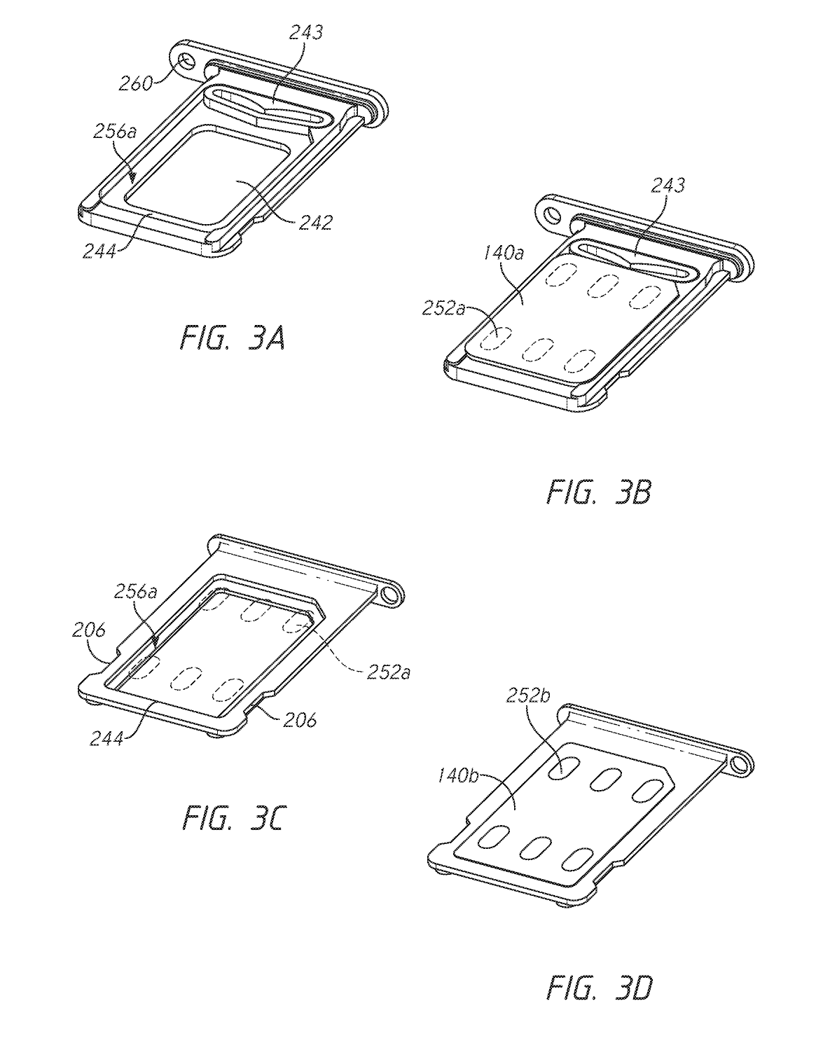

Frame 254 of SIM card tray 205 may include a recessed opening 242 (e.g., a window) extending through the first and second receptacles 256a, 256b. Opening 242 allows a user to more easily remove a SIM card held or retained in one of the tray receptacles 256, as described in more detail below with respect to FIGS. 3A-3D. Including opening 242 in SIM card tray 205 may also reduce material costs and weight of the tray 205. Further, in various embodiments, SIM card tray 205 may also have a faceplate 258 with an aperture 260, as discussed in more detail below. In some embodiments SIM card tray 205 may be made from a metal such as, but not limited to aluminum or stainless steel. In various embodiments, SIM card tray 205 may be made from a plastic material.

With reference to FIGS. 3A-3D, at least one of the receptacles 256 of SIM card tray 205 may include a retention mechanism 243 configured to retain or secure one of the SIM cards 140 within the respective receptacle. For example, receptacle 256a on a back or bottom side of tray 205 includes retention mechanism 243 to secure SIM card 140a or 140b in position within tray 205. As illustrated in FIGS. 3B-3C, retention mechanism 243 is configured to retain a SIM card 140 within receptacle 256a such that it does not fall out when tray 205 is oriented “right side up” to be inserted into SIM card connector 145. Front or top side of tray 205 may not need a retention mechanism 243 as the receptacle 256b is oriented upward to hold a SIM card. However, in some embodiments, receptacle 256b also includes a retention mechanism 243 for improved securement of a SIM card 140 within the receptacle. In some embodiments, the retention mechanism 243 may include, for example: a molded plastic spring, elastomer spring, liquid silicone-rubber spring, metal spring, plastic retention feature, or any combination thereof.

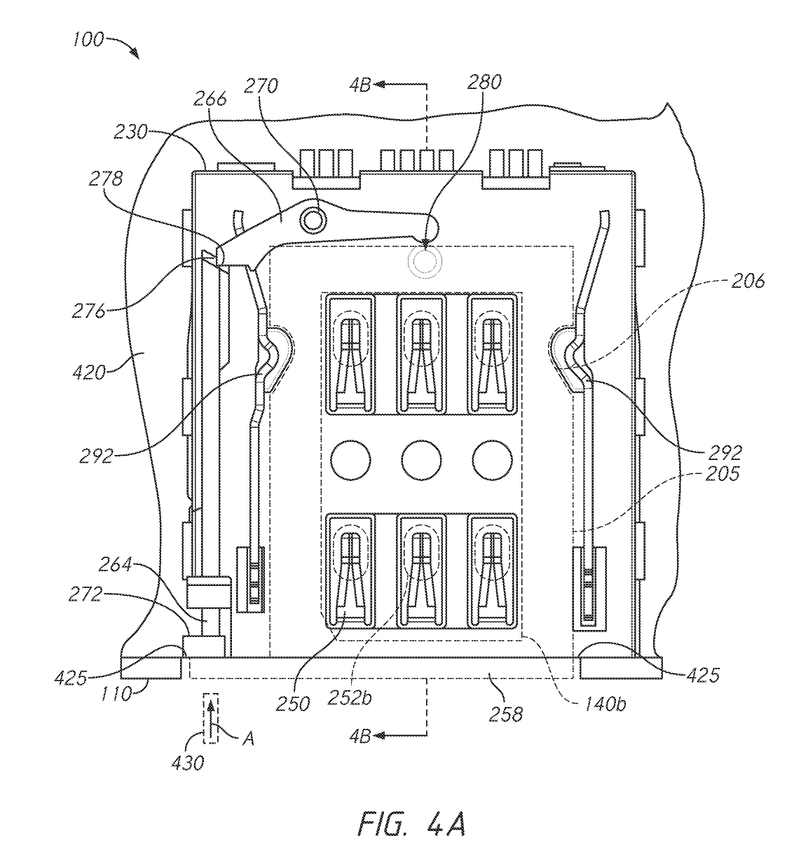

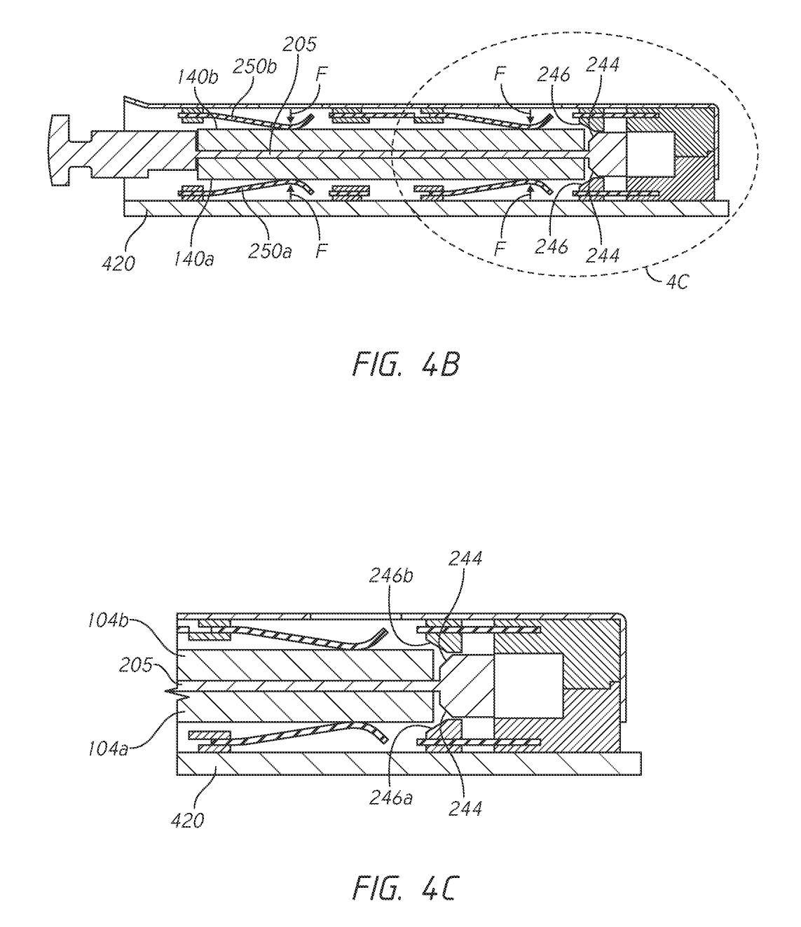

As discussed above, SIM card tray 205 may include recessed opening 242. As illustrated in FIG. 3C, recessed opening 242 may allow a user to be able to punch or push through opening 242 to remove or eject a SIM card (e.g., SIM card 140a retained by the retention mechanism 243 within tray receptacle 256a) from SIM card tray 205. Opening 242 may provide SIM card tray 205 with improved flexibility such that a user may flex or twist tray 205 to remove a secured or retained SIM card 140. Further, in various embodiments, one or both of the receptacles 256 may include a chamfered (e.g., sloped, ramped, beveled) rear edge 244 (see FIGS. 4B-4C). Chamfered rear edge 244 extends between opposing sides of a respective receptacle 256. Such a chamfered rear edge 244 may reduce a likelihood of SIM card tray 205 being entangled with (e.g., snagging) a portion of connector housing 210 (e.g., electrical contacts 250) when SIM card tray 205 is ejected or removed from SIM card connector 145, as described in more detail below.

Referring back to FIG. 2, in some embodiments, a cover 284 (e.g., a shield) may be secured to and disposed over connector housing 210 to provide mechanical stability and/or electromagnetic shielding. In some embodiments, cover 284 may be made from a metal such as a copper based alloy or a stainless steel. In some embodiments, one or more latches 292 (e.g., a pair of latches) within connector housing 210 may be configured to secure SIM card tray 205 within cavity 286 when in a latched position, and a SIM card tray ejection mechanism 262 may be configured to eject the SIM card tray from the latched position, as described in more detail below.

SIM card connector 145 may have a SIM card tray ejection mechanism 262 contained within SIM card connector 145 and configured to eject SIM card tray 205 when actuated, causing the SIM card tray to protrude out of receiving opening 245 so it can be accessed by a user. SIM card tray ejection mechanism 262 may include a pushrod 264 and an ejector arm 266 pivotably coupled to connector housing 210 (e.g., lower connector housing portion 210a). Pushrod 264 may be disposed in a slot disposed within connector housing 210. The slot may extend from bottom surface 215 (e.g., bottom surface 215a of the lower connector housing portion 210a) into cavity 240 and may be positioned adjacent to and along a portion of first sidewall 220 (e.g., first sidewall 220a). Pushrod 264 may be configured to translate linearly within the slot to contact ejector arm 266. In some embodiments, ejector arm 266 may be configured to be actuated by pushrod 264 to eject SIM card tray 205, as described below. In some embodiments SIM card ejection mechanism 262 may have a different configuration without departing from the scope of this disclosure.

Now referring to FIG. 4A, a cross-section through electronic device 100 housing 105 is shown in the region of SIM card connector 145, showing a plan view of SIM card tray 205 in a latched position within the SIM card connector. Cover 284 and upper connector housing 210b are removed and SIM card tray 205 and SIM card 140 are shown with hidden lines for clarity. As discussed above, in some embodiments latches 292 may protrude from one or more sidewalls 220, 225 of cavity 240 and secure SIM card tray 205 within the cavity by fitting within corresponding depressions 206 within SIM card frame 254. In various embodiments, latches 292 may be a portion of connector housing 210 or may be separate metallic members secured to the connector housing. In some embodiments, a different latching mechanism may be used, for example, an overmolded metallic spring.

While in the latched position, SIM card tray 205 may hold SIM card 140 in an installed position such that plurality of electrical contacts 250 disposed within cavity 240 make contact with plurality of SIM card contacts 252 depending on whether SIM cards 140 are held in first receptacle, second receptacle, or both receptacles. While in the latched position, in some embodiments, faceplate 258 of SIM card tray 205 may form a portion of exterior surface 110 of electronic device 100. In various embodiments, SIM card tray 205 may be located within an electronic device or within a compartment of the electronic device such as, but not limited to a battery compartment. In some embodiments, plurality of electrical contacts 250 may be configured to make contact with SIM card contacts 252 and couple to a circuit board 420 such that circuitry on the circuit board may communicate with circuitry within one or more SIM cards 140. In various embodiments, each of SIM cards 140 may contain an integrated circuit chip that securely stores the international mobile subscriber identity (IMSI) number and its related key, which are used to identify and authenticate subscribers on mobile telephony devices. In various embodiments contacts or other information may also be stored on SIM cards 140.

As discussed above, in some embodiments SIM card tray ejection mechanism 262 (see FIG. 2) may be fully contained within SIM card connector 145. This may enable both a smaller penetration aperture through housing 105 of electronic device 100 and the ability to seal SIM card connector 145 to the housing to impede moisture ingression into electronic device 100, as discussed in more detail below. In some embodiments, housing 105 of electronic device 100 may serve as a primary structural component of the electronic device. As a result, the smaller the size of the penetration aperture through the housing for SIM card connector 145 the higher the strength of the housing. In various embodiments, by integrating SIM card tray ejection mechanism 262 (see FIG. 2) within SIM card connector 145, the penetration within housing 105 may only need to be large enough to accommodate SIM card tray 205 sliding into and out of the housing. Thus, additional housing material may not have to be removed as compared to an alternative design that may have an external ejection mechanism that may be placed, for example above or below the SIM card connector. Further, in some embodiments, having a stacked SIM card connector 145 and corresponding tray, may reduce or minimize an amount of housing material to be removed relative to a side-by-side or in-line SIM card connector and tray design for holding multiple SIM cards.

Further, in some embodiments, by integrating SIM card tray ejection mechanism 262 (see FIG. 2) within SIM card connector 145, the connector enclosure may be substantially sealed since there is no need for an external ejection mechanism to interface with SIM card tray 205 within SIM card connector 145. In some embodiments, a gasket 425 may be disposed between SIM card connector 145 and housing 105 of electronic device 100 to seal the SIM card connector to the housing. Cavity 240 may be substantially closed and sealed to housing 105 such that the moisture cannot enter the inside of electronic device 100. This may improve the ability of electronic device 100 to withstand exposure to moisture. In various embodiments, gasket 425 may be made from an elastomeric or foam material and may have one or more layers of a pressure sensitive adhesive (PSA).

As discussed above, FIG. 4A illustrates SIM card tray 205 in the installed position where faceplate 258 may be substantially flush with exterior surface 110 of electronic device 100 to provide a substantially continuous and aesthetically pleasing exterior surface. To eject SIM card tray 205, in some embodiments an ejection tool 430 may be positioned outside of electronic device 100 and oriented such that it can penetrate through aperture 260 in faceplate 258 and push on a head portion 272 of pushrod 264 such that the pushrod is linearly translated in a first direction (e.g., as illustrated by arrow A) towards rear wall 230. As illustrated in FIG. 2, in some embodiments head portion 272 may have a depression 274 that may assist tool 430 remaining located on the head portion and not sliding off the side when the tool is pushed.

As pushrod 264 is linearly translated towards rear wall 230, contact portion 276 pushes against a pushrod contact portion 278 of ejector arm 266. The force on pushrod contact portion 278 of ejector arm 266 causes the ejector arm to pivot in a clockwise direction about pin 270 and as a result tray ejection portion 280 of the ejector arm moves in a second direction (e.g., opposite the first direction) that is away from rear wall 230. As tray ejection portion 280 continues to move away from rear wall 230, it contacts SIM card tray 205 and applies an ejection force in the second direction to the SIM card tray. When the ejection force on SIM card tray 205 overcomes the retention force applied by the one or more latches 292, the SIM card tray is ejected so that a user can grasp the SIM card tray and fully remove it from cavity 240. A user may install one or more SIM cards 140 and SIM card tray 205 by sliding the SIM card tray through receiving opening 245 and pushing it into the cavity 240 until the one or more latches 292 are engaged.

Now referring to FIGS. 4B-4C, cross-section and detailed views, respectively, of the plan view of SIM card tray 205 in a latched position within the SIM card connector 145 of FIG. 4A are illustrated. As discussed above and illustrated in FIGS. 4B-4C, each of receptacles 256a, 256b on opposing sides of SIM card tray 205 may include rear chamfered edges 244. When tray 205 is ejected from connector 145 (e.g., in the second direction out of cavity 240), chamfered edges 244 are angled such that tray 205 may more easily slide in the second direction out of cavity 240 past electrical contacts 250 without ensnaring or snagging electrical contacts 250.

Further, in various embodiments, connector housing 210 may include ramped surfaces 246. For example, each of lower and upper connector housing portions 210a, 210b may include corresponding rear ramped surfaces (e.g. identified individually as lower and upper ramped surfaces 246a, 246b). The ramped surfaces 246 may substantially ensure or maintain a desired depth or position (e.g., along a Z-axis) of tray 205 within the connector housing 210 whether a single SIM card or dual SIM cards 140 are held within tray 205. As illustrated in FIGS. 4B-4C, when SIM cards 140a and 140b are held in respective receptacles 256 of tray 205, a biasing force F from respective contacts 250 are balanced upon tray 205. Contacts 250a push up and contacts 250b push down upon SIM cards 140a and 140b, respectively. When only a single SIM card 140 is held in one of the receptacles 256 of a dual SIM card tray or a SIM card tray with only a single receptacle and SIM card is inserted, a biasing force upon tray 205 may be relatively unbalanced. That is, only one set of contacts 250 (e.g., either contacts 250a or contacts 250b) biases against the single SIM card 140 held in the tray. This unbalanced biasing force may push the tray 205 out of a desired depth or position such that proper contact between corresponding electrical contacts 250 and SIM card contacts 252 is not maintained. Therefore, ramped surfaces 246 may help guide or maintain a desired position of tray 205 such that contact is maintained (e.g., between contacts 250, 252) whether a tray with a single SIM card 140 or dual SIM cards 140 is inserted into the connector.

Although electronic device 100 (see FIG. 1) is described and illustrated as one particular electronic device (i.e., a cellular telephone), embodiments of the invention are suitable for use with a multiplicity of electronic devices. For example, any device that receives or transmits audio, video or data signals may be used with the invention. In some instances, embodiments of the invention are particularly well suited for use with portable electronic media devices including cellular telephony because of their potentially small form factor. As used herein, an electronic media device includes any device with at least one electronic component that may be used to present human-perceivable media. Such devices may include, for example, portable music players (e.g., MP3 devices and Apple's iPod devices), portable video players (e.g., portable DVD players), cellular telephones (e.g., smart telephones such as Apple's iPhone devices), video cameras, digital still cameras, projection systems (e.g., holographic projection systems), gaming systems, PDAs, as well as tablet (e.g., Apple's iPad devices), laptop or other mobile computers. Some of these devices may be configured to provide audio, video or other data or sensory output.

For simplicity, various internal components, such as the control circuitry, graphics circuitry, bus, memory, storage device and other components of electronic device 100 (see FIG. 1) are not shown in the figures.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

References throughout the foregoing description to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the present invention may be combined in any suitable manner in one or more embodiments. One skilled in the relevant art will recognize that the present invention can be practiced without one or more of the specific features or advantages of a particular embodiment. In other instances, additional features and advantages may be recognized in certain embodiments that may not be present in all embodiments of the present invention.

Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

Additionally, spatially relative terms, such as “bottom or “top” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface may then be oriented “above” other elements or features. The device may be otherwise oriented (e.g., rotated 90 degrees or at other orientations) and the spatially relative descriptors used herein interpreted accordingly.

What is claimed is:

1. A dual subscriber identity module (SIM) card connector comprising:
a lower connector housing portion having a bottom surface;
an upper connector housing portion having a top surface, the upper connector housing portion coupled to the lower connector housing portion to define an opening for a receiving space between the upper and lower connector housing portions, wherein the opening and the receiving space are sized and shaped to slidably receive a SIM card tray;
a first plurality of electrical contacts disposed at the bottom surface of the lower connector housing portion and configured to make contact with a first SIM card disposed on a first side of the SIM card tray when the SIM card tray is received within the receiving space; and
a second plurality of electrical contacts disposed at the top surface of the upper connector housing portion and configured to make contact with a second SIM card disposed on a second side of the SIM card tray opposite the first side when the SIM card tray is received within the receiving space.

2. The SIM card connector of claim 1 wherein the lower and upper connector housing portions are integrally formed.

3. The SIM card connector of claim 1 wherein the upper connector housing portion includes a pair of opposing sidewalls and a rear wall extending between the opposing sidewalls, the opposing sidewalls and rear wall extending from the top surface and are configured to be coupled to the lower connector housing portion.

4. The SIM card connector of claim 1 wherein the lower connector housing portion includes a pair of opposing sidewalls and a rear wall extending between the opposing sidewalls, the opposing sidewalls and rear wall extending from the bottom surface and are configured to be coupled to the upper connector housing portion.

5. The SIM card connector of claim 1 wherein the first and second plurality of electrical contacts are configured to be electrically coupled to a circuit board.

6. The SIM card connector of claim 1 wherein each of the SIM cards has a plurality of SIM card contacts configured to be coupled to the first or second plurality of electrical contacts when the SIM card tray is in a latched position within the receiving space.

7. The SIM card connector of claim 1 wherein the opening is disposed at a front face of the upper and lower connector housing portions and the front face is configured to mate to a housing of an electronic device with a gasket such that a seal is formed between the connector and the housing of the electronic device.

8. The SIM card connector of claim 1 wherein the bottom surface of the lower connector housing portion includes a first ramped surface and the top surface of the upper connector housing portion includes a second ramped surface, the first and second ramped surfaces configured to maintain a position of the SIM card tray when the SIM card tray is received within the receiving space.

9. The SIM card connector of claim 1 further comprising the SIM card tray, the SIM card tray configured to hold the first and second SIM cards in a stacked configuration such that SIM card contacts of the respective SIM cards face opposing directions.

10. The SIM card connector of claim 9 wherein the SIM card tray includes receptacles on opposing sides configured to hold the first and second SIM cards, respectively.

11. The SIM card connector of claim 10 wherein each of the receptacles of the SIM card tray includes a rear chamfered edge.

12. An electronic device comprising:
a housing;
a connector enclosure disposed within the housing and having a receiving opening that communicates with a cavity;
a tray configured to hold a subscriber identity module (SIM) card and be inserted within the cavity through the receiving opening;
a first plurality of electrical contacts disposed on a lower surface of the connector enclosure; and
a second plurality of electrical contacts disposed on an upper surface of the enclosure, wherein one of the first or second plurality of electrical contacts is configured to make a plurality of electrical connections between the SIM card and a circuit board when the tray is received within the cavity.

13. The electronic device of claim 12 wherein the tray is configured to hold only one SIM card.

14. The electronic device of claim 12 wherein the tray includes receptacles on opposing sides configured to hold first and second SIM cards in a stacked configuration such that electrical contacts of the first SIM card make contact with the first plurality of electrical contacts and electrical contacts of the second SIM card make contact with the second plurality of electrical contacts when the tray is received within the cavity.

15. The electronic device of claim 14 wherein each of the receptacles of the tray includes a rear chamfered edge.

16. The electronic device of claim 14 wherein at least one of the receptacles includes a retention mechanism configured to secure the first or second SIM card within the receptacle.

17. The electronic device of claim 12 wherein the upper and lower surfaces of the enclosure include first and second ramped surfaces, respectively.

18. The electronic device of claim 12 further comprising a cover configured to be disposed over at least a portion of the connector enclosure.

19. A subscriber identity module (SIM) tray assembly, comprising:
a first and second opposing sides;
a first receptacle on the first side configured to hold a first SIM card therein; and
a second receptacle on the second side configured to hold a second SIM card therein such that the first and second SIM cards are held in a stacked configuration, wherein each of the first and second receptacles includes a rear chamfered edge.

20. The SIM tray assembly of claim 18 wherein at least one of the receptacles includes a retention mechanism configured to secure the first or second SIM card within the receptacle.
